(19) United States
(12) Patent Application Publication
(10) Pub. No.: US 2024/0405313 A1
(43) Pub. Date: Dec. 5, 2024

(54) THERMAL MANAGEMENT OF BATTERY SYSTEMS

(71) Applicant: Caterpillar Inc., Peoria, IL (US)

(72) Inventors: Suresh Baddam REDDY, Peoria, IL (US); Dustin Craig SELVEY, Eureka, IL (US); Umakanth SAKARAY, Dunlap, IL (US)

(73) Assignee: Caterpillar Inc., Peoria, IL (US)

(21) Appl. No.: 18/325,569

(22) Filed: May 30, 2023

(51) Int. Cl. H01M 10/63; H01M 10/617; H01M 10/625

(52) U.S. Cl. CPC H01M 10/63; H01M 10/617; H01M 10/625; H01M 2220/20

(57) ABSTRACT

A method of thermally managing a battery system including enabling a sleep mode, the sleep mode causing the battery system to maintain a capability to control a temperature of a main storage battery of the battery system with a temperature control system while the machine is not in operation; monitoring a battery temperature; activating an externally powered battery management mode when connected to one or more external power sources, to heat or cool the main storage battery based on the battery temperature of the main storage battery as determined by the temperature control system, to charge the main storage battery, or to charge the auxiliary battery; and activating an internally powered thermal battery management mode when isolated from external power sources, to heat or cool the main storage battery, the internally powered battery management mode being different than the externally powered battery management mode.

### TECHNICAL FIELD

The present disclosure relates generally to thermal management of battery systems, and more particularly, to thermal management of battery systems based on whether the battery system is receiving an external electrical charge.

### BACKGROUND

Mobile machines are increasingly powered by rechargeable electric storage batteries, which electric storage batteries can be, in some instances, the only source of power for these machines. The machines could be used in varying climates, including extreme climates and in temperatures above and below optimal operating temperatures for the storage batteries. Existing battery temperature control systems could be inadequate for such climates. Problems with heating and cooling battery systems can be compounded by limited storage capacity and a desire to limit electrical power drain from the batteries to heat and cool the battery and associated systems. Further, for at least some conventional systems, allowing operation of accessory systems, such as cooling and/or heating systems, while the system is off can potentially create unsafe conditions.

U.S. Pat. No. 9,969,293, (“the '293 patent”), describes battery thermal conditioning to extend a battery useful life in electrified vehicles including a battery assembly that is either heated or cooled using a battery thermal management system configured to thermally manage the battery assembly during vehicle OFF conditions. The thermal management system is powered using grid power from an external power source or battery power from the battery assembly. However, the '293 patent may not provide a capability to enable a “sleep mode” in the machine or energy storage system, which mode may enable cooling or heating systems to activate automatically under appropriate conditions in order to keep storage battery temperatures within limits to allow a system start and use without excessive draining of battery power.

The features of the present disclosure could solve one or more of the problems set forth above and/or other problems in the art. The scope of the current disclosure, however, is defined by the attached claims, and not by the ability to solve any specific problem.

### SUMMARY

In one aspect, a method of thermally managing a battery system, includes enabling a sleep mode, the sleep mode causing the battery system to maintain a capability to control a temperature of a main storage battery of the battery system with a temperature control system while the machine is not in operation; monitoring a battery temperature of the main storage battery using the temperature control system, wherein the temperature control system is configured to receive power from an auxiliary battery; activating an externally powered battery management mode when connected to one or more external power sources, to heat or cool the main storage battery based on the battery temperature of the main storage battery as determined by the temperature control system, to charge the main storage battery, or to charge the auxiliary battery; and activating an internally powered thermal battery management mode when isolated from external power sources, to heat or cool the main storage battery based on the battery temperature of the main storage battery, the internally powered battery management mode being different than the externally powered battery management mode.

In another aspect, a system for temperature control in a battery system configured to provide electrical power to a mobile machine from a main storage battery including a main storage battery configured to receive an electrical charge from an external charger; a temperature control system; an auxiliary battery; a processor; and a memory storing one or more instructions, that when executed by the processor cause the system to: enable a sleep mode, the sleep mode causing the battery system to maintain a capability to control a temperature of the main storage battery of the battery system with the temperature control system while operation of the mobile machine is deenergized; monitor battery temperature of the main storage battery using the temperature control system, wherein the temperature control system is powered by the auxiliary battery; activate an externally powered thermal battery management mode when connected to external power sources to heat or cool the main storage battery based on the battery temperature of the main storage battery as determined by the temperature control system, to charge the main storage battery, or to charge the auxiliary battery; and activate an internally powered battery management mode when not connected to external power sources to heat or cool the main storage battery based on the battery temperature of the main storage battery, the internally powered battery management mode being different than the externally powered thermal battery management mode.

In yet another aspect, a method of thermally managing a battery system of a mobile machine includes enabling a sleep mode using a sleep mode enabling selection, the sleep mode causing the battery system to maintain a capability to control a temperature of a main storage battery of the battery system with a temperature control system while operation of the mobile machine is deenergized; monitoring battery temperature of the main storage battery using the temperature control system, wherein the temperature control system is configured to operate between 0 to 45 degrees Celsius; activating an externally powered thermal battery management mode when connected to external power sources to heat or cool the main storage battery based on the battery temperature of the main storage battery as determined by the temperature control system, to charge the main storage battery, or to charge an auxiliary battery; and activating an internally powered battery management mode when not connected to external power to heat or cool the main storage battery based on the battery temperature of the main storage battery, the internally powered battery management mode being different than the externally powered thermal battery management mode.

### BRIEF DESCRIPTION OF THE DRAWINGS

FIG. 1 is a block diagram of a thermal management system for a battery, according to aspects of the disclosure.

FIG. 2 is a block diagram that shows additional aspects of the thermal management system of FIG. 1.

FIG. 3 shows additional aspects of the thermal management system of FIG. 1.

FIG. 4 provides a flowchart depicting an exemplary method for operating the thermal management system of FIG. 1.

### DETAILED DESCRIPTION

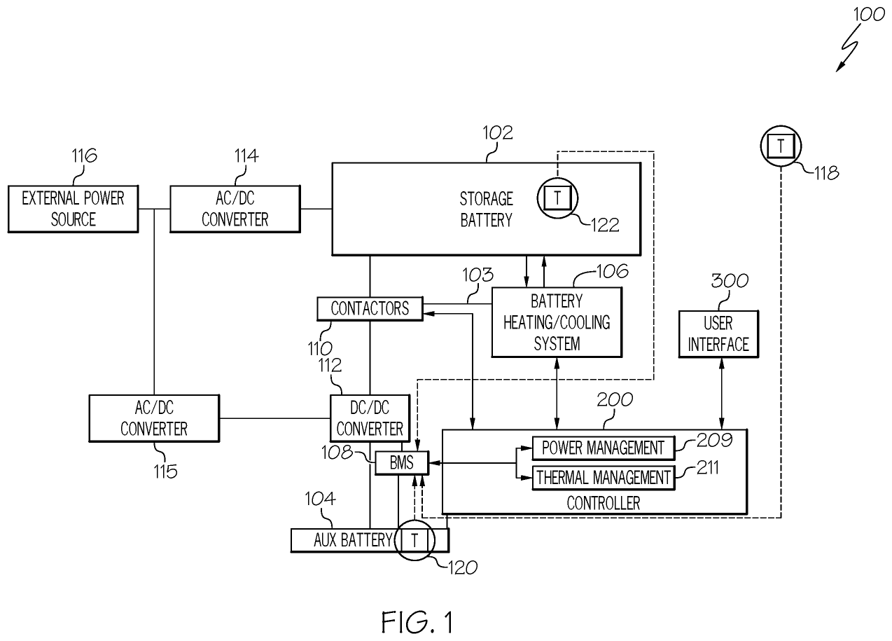

FIG. 1 illustrates a battery thermal management system 100. In the figure, solid lines without arrows represent electric supply lines, lines with double arrows represent signal lines in which a signal could be passed in two directions, and dashed lines represent a signal line from a temperature sensor. The battery thermal management system 100 may be used to maintain a temperature in a battery of, for example, a stationary or mobile energy storage device (e.g., a grid-connected or off-grid energy storage system, generator system, etc.), an electrified vehicle such as an electrified mobile machine, or other battery-powered machines or devices. As used herein, the term machine may include mobile machine as well as an energy storage system (ESS) power generation system. The battery thermal management system 100 includes a main storage battery 102. The main storage battery 102 (which may be the highest capacity battery of a machine powered by the battery system) is configured to receive and store an electrical charge from an external power source 116 (e.g., an electric grid, an energy storage system, a generator, etc.) through an AC/DC converter 114 and managed by a battery management system (BMS) 108. The BMS 108 may be separate from the controller 200 (as depicted) or, in some embodiments, may be a component of the controller 200.

The system 100 could further include a DC/DC converter (not depicted) for stepping up/down voltages as necessary for storing in the main storage battery 102. The main storage battery 102 is electrically connected to an auxiliary battery 104 via a DC/DC converter 112 and one or more contactors 110. In some embodiments, the auxiliary battery 104 may be coupled to the external power source 116 through an AC/DC converter 115 and the DC/DC converter 112, which external power source 116 may provide external power to charge the auxiliary battery 104 and/or power the battery auxiliaries through the auxiliary battery 104. The main storage battery could be a Li-ion battery, for example, or another type of battery (e.g., lead acid, nickel cadmium, etc.) In some embodiments, the auxiliary battery 104 could also be a Li-ion battery, for example, or another type of battery (e.g., lead acid). In some embodiments, the main storage battery 102 and the auxiliary battery 104 have different operational characteristics as described in greater detail herein. For instance, the auxiliary battery 104 has a wider operational temperature range than the main storage battery 102 and the main storage battery 102 has a capacity to store more electrical energy than the auxiliary battery 104.

The system 100 can include a temperature control system 106 (i.e., a battery heating and/or cooling system), which can include one or more features for maintaining a temperature within the main storage battery 102 and/or the auxiliary battery 104 (e.g., an HVAC system providing cooling through coolant supply and return 103 (which is merely one exemplary type of system and other systems are considered)). The controller 200 can control operation of the system 100 and may include a power management module 209 and a thermal management module 211. The modules may generate signals for controlling operation of the system 100 as described in greater detail herein. The controller 200 may be communicatively coupled to a user interface 300 for receiving one or more user inputs and generating signals for communicating these inputs to controller 200. The system 100 further includes one or more temperature sensors for sensing temperatures of various components and the ambient environment. For example, the system 100 includes an ambient temperature sensor 118 for measuring a temperature of the ambient (or that temperature to which the battery would tend to heat or cool when deenergized), an auxiliary battery temperature sensor 120, and a storage battery temperature sensor 122. In some embodiments, the thermal management module 211, the power management module 209, and the BMS 108 receive electrical power from one or more of the main storage battery 102, the auxiliary battery 104, and the external power sources 116. For example, the thermal management module 211, the power management module 209, and the BMS 108 may receive electrical power from the external power sources 116 through the AC/DC converter 115 and the DC/DC converter 112 in embodiments including these features. In embodiments not including the AC/DC converter 115 and the DC/DC converter 112, the the thermal management module 211, the power management module 209, and the BMS 108 may receive electrical power from one or more of the main storage battery 102 or the auxiliary battery 104.

The temperature control system 106 receives temperature range limits (e.g., maximum and minimum operating limits, etc.) and charge limits and discharge limits from the BMS 108. The limits may be provided through the controller 200 or directly via a connection between the BMS 108 and the temperature control system 106. The BMS 108 receives battery temperature measurements from the temperature sensor 122, the temperature sensor 118, and the temperature sensor 120. In some embodiments, the controller 200 may receive measurements from the temperature sensor 122, the temperature sensor 118, and the temperature sensor 120.

In embodiments, the temperature control system 106 may be powered by three different sources: the main storage battery 102, the auxiliary battery 104, and/or the external power source 116. For example, in embodiments including the ac/dc converter 115, the temperature control system 106 ay receive electrical power from the external power sources 116 directly, such as, for example, when the main storage battery 102 or the auxiliary battery 104 does not provide electrical power to the temperature control system 106. In some embodiments, the auxiliary battery 104 or the main storage battery 102 may provide electrical power to the temperature control system 106 when/if there is not one or more ac/dc converters or other means for providing electrical power to the temperature control system 106 from the external power sources 116.

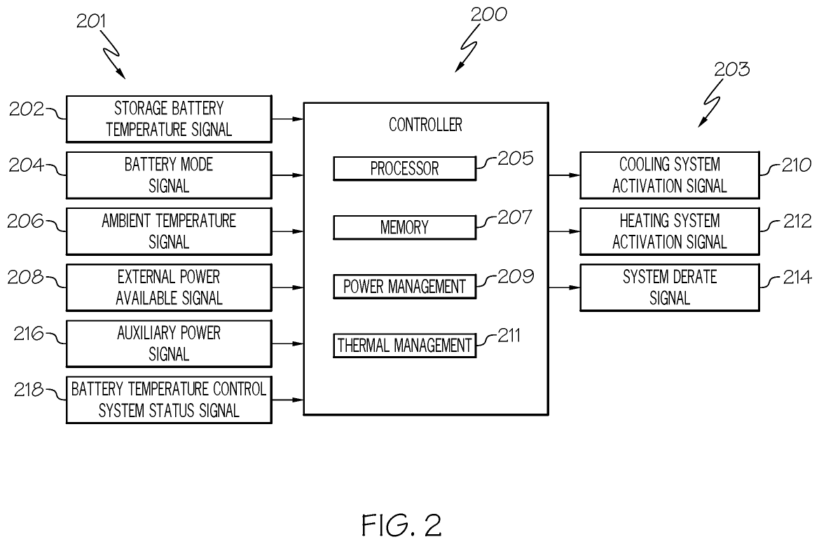

FIG. 2 shows an example configuration of the controller 200 in greater detail. The controller 200 may include a processor 205 and a memory 207. The controller 200 may be an electronic control module (ECM) and can be communicatively coupled to or otherwise include one or more modules or systems for carrying out one or more functions of the system 100 based on input data 201. The processor 205, which can comprise a single processor or multiple processors configured to receive inputs, display outputs, and generate commands to control the operation of components of the system 100.

The memory 207 may include one or more memories, a secondary storage device, networking interfaces, or any other means for accomplishing tasks consistent with the present disclosure. The memory or secondary storage device associated with controller 200 may store data and software to allow the controller 200 to perform its functions, including the functions described below. The memory 207 may store, for example, one or more predefined values to which an ambient temperature may be compared when performing one or more functions of the system, as described in greater detail herein. One or more of the devices or systems communicatively coupled to the controller 200 may be communicatively coupled over a wired or wireless network, such as the Internet, a Local Area Network, WiFi, Bluetooth, or any combination of suitable networking arrangements and protocols.

The controller 200 is configured to generate one or more outputs 203 to control operation of the system 100 based on input data from the one or more inputs 201. Input data 201 can include a storage battery temperature signal 202 generated by the main storage battery temperature sensor 122, a battery mode signal 204 generated, for example, based on a user input from the user interface 300, an ambient temperature signal 206 generated based on the ambient temperature sensor 118, an external power available signal 208 as received from the BMS 108 based on whether or not the system is receiving a charge from the external power source 116 (e.g., an external power grid, a generator, etc.), an auxiliary power signal 216 based on a status of the auxiliary battery 104, and a battery temperature control system status signal 218 as received from the battery temperature control system 106, which may be a system for heating and/or cooling the main storage battery 102, based on operation of the battery temperature control system 106. Based on the various inputs 201, the controller 200 generates outputs 203 including a cooling system activation signal 210 as generated by the thermal management module 211, a heating system activation signal 212 as generated by the thermal management module 211, and a system derate signal 214 as generated by the power management module 209. The system derate signal 214 serves as a signal for derating (or lowering) a power signal for an overall output of the machine and thus an overall output of the main storage battery 102, or may cause a derating of only the main storage battery 102.

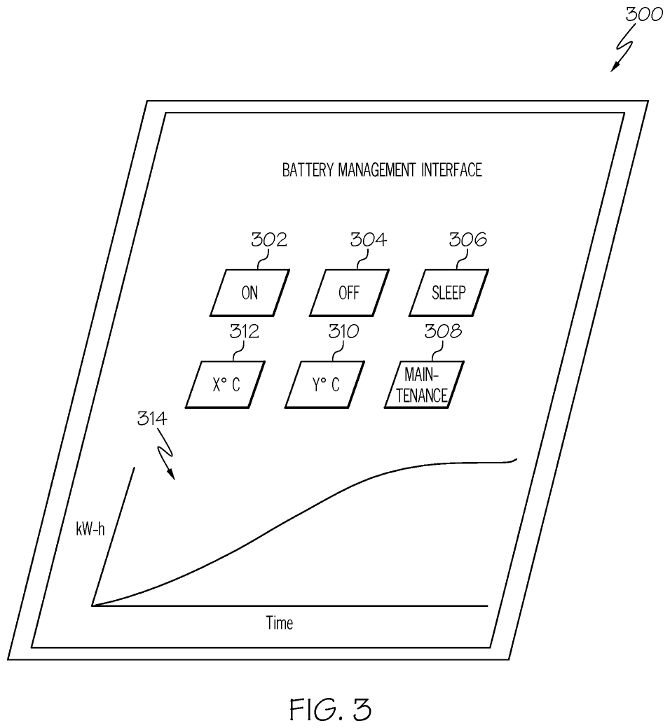

FIG. 3 shows a user interface 300 for controlling one or more aspects of the system 100. The user interface 300 includes various mode selectors, for example, an “on” selector 302, an “off” selector 304, a “sleep” selector 306, and a “maintenance” selector 308. A user may engage or disengage selectors 302, 304, 306, and 308 by interacting with an element of a touch screen, manipulating a physical button, etc. The user interface 300 may provide the user with various information about the system 100, for example, a storage battery temperature indication 310 as determined, for example, from the main storage battery temperature sensor 122, an auxiliary battery temperature indication 312 as determined, for example, from the auxiliary battery temperature sensor 120, and a battery charge status indicator 314 based on one or more signals from the BMS 108.

### INDUSTRIAL APPLICABILITY

The disclosed aspects of the battery system of the present disclosure could be used to maintain a temperature of a main storage battery for a stationary or mobile energy storage device, a vehicle (e.g., a mobile machine), or other system within a desired temperature range based on whether or not the main storage battery is receiving a charge or not. In general, the system may be configured to maintain the main storage battery within a tighter temperature range (expending more energy to keep the temperature within a more optimum temperature range) if external electrical power is available and/or if the system is charging the main storage battery because more energy will be available if there is an external source of electrical power available. In embodiments, the system may determine whether or not a sleep mode is enabled and based on the determination may continuously monitor temperature in order to energize heating or cooling systems as needed. In the sleep mode the quiescent power draw is minimal.

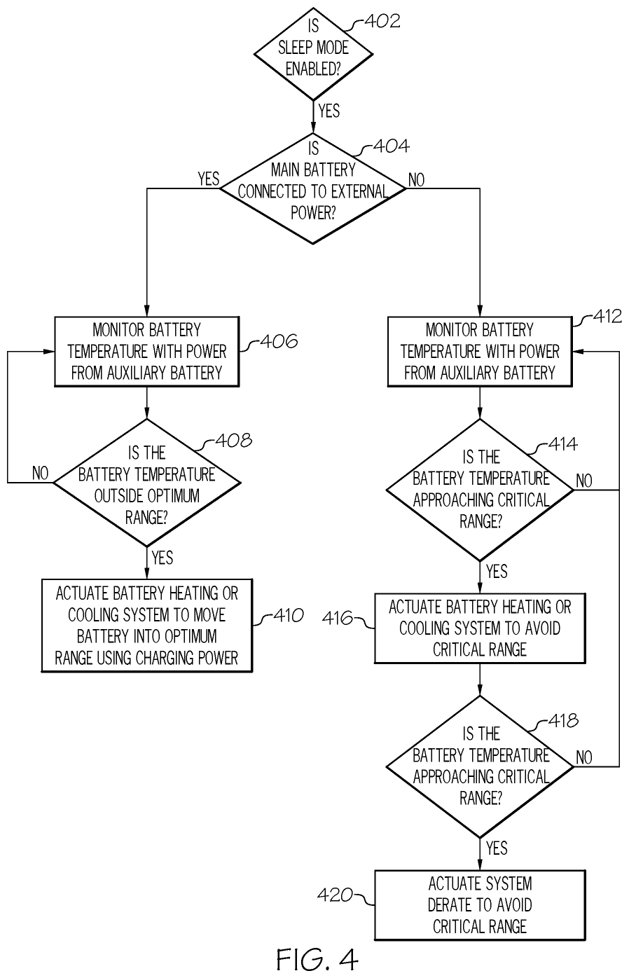

With reference to FIG. 4, at step 402 controller 200 may determine whether a sleep mode is enabled. Whether the sleep mode is enabled may be determined based on, for example, a battery mode signal 204 as received at the power management module 209 and/or the thermal management module 211. The sleep mode may be selected by a user of the system using, for example, the user interface 300 of FIG. 3 causing the battery mode signal 204 to indicate the sleep mode is selected and generating an appropriate battery mode signal 204. For example, a user may select the sleep mode selector 306 when a current use of the machine is complete. In some embodiments, the user may be able to select the sleep mode based on one or more of a main storage battery temperature as shown by the main storage battery temperature indicator 312 or an auxiliary battery temperature as shown by the auxiliary battery temperature indicator 310 and/or a charge status as shown by the charge status indicator 314.

The sleep mode selector 306 may be used to distinguish the sleep mode from, for example, an on mode in which the machine (e.g., vehicle) or stationary power storage/generation system is operable and the battery system 100 is on and powering the vehicle, an off mode in which the vehicle and its battery systems are deenergized, and/or a maintenance mode in which the machine or stationary power storage/generation system and some of its systems may be operable in one or more modes distinguished from the on mode and the off mode.

In aspects, the sleep mode may that mode in which the system may cause the battery system to maintain a capability to control a temperature of a storage battery of the battery system with a temperature control system (e.g., the battery temperature control system 106 of FIG. 1) while the machine is not in operation. The battery temperature control system 106 may receive a signal from the controller 200 caused by the user selecting the sleep mode selector 306 on the user interface 300.

At step 404, once the sleep mode has been selected, the system may cause an availability of an external power connection status (“external power available status”) to be determined. For example, the system may determine whether or not the overall system is electrically connected to an external power source (e.g., a utility powered electric vehicle supply equipment (EVSE), an electric grid, a generator (for example, with a larger capacity than the main storage battery), etc.) This determination can be based on a voltage level external to the system (as measured at the connection between the external power source 116 and the AC/DC converter 114 to the main storage battery 102 for charging and/or the AC/DC converter 115 to the auxiliary battery 104 and/or controller 200, for example). The external power source 116 may, in some embodiments, be connected directly to the auxiliary battery 104 and/or the controller 200 via the AC/DC converter 115 and the DC/DC converter 112. This may enable the auxiliary battery 104 to power the power management module 209 and thermal management module 211 directly when the auxiliary battery 104 receives a charge from the external power source 116.

The external power available status may be indicative of whether or not the main storage battery 102 of the battery system 100 is electrically connected to an external power source and/or capable of being electrically charged. For example, the external power available status may indicate whether the main storage battery 102 is receiving a charge from the external power source 116 or is electrically coupled with external grid electrical power or another electrical power source. The determination may be based on a signal from the BMS 108 (e.g., the external power available signal 208). That is, if the main storage battery 102 is receiving an electrical charge from an external source, the BMS 108 may send a signal to the controller 200.

At step 406, the system may monitor a battery temperature with power from the auxiliary battery 104. For example, the temperature sensor 122 of the main storage battery 102 may be powered by the auxiliary battery 104 and the signal generated by the temperature sensor 122 may be used to generate a signal to the controller 200 in proportion to the temperature of the main storage battery 102. In embodiments, the auxiliary battery 104 may have a larger operational temperature range than the main storage battery 102 such that it can continue to operate even if, for example, the main storage battery 102 is deenergized based on ambient temperature or for another reason.

The temperature signal may be provided to the controller 200 through, for example, the BMS 108. At step 408, the temperature of the main storage battery 102 may be compared to a temperature range (e.g., an optimum range such as, for example, about 15 to about 35 degrees Celsius) to determine whether the temperature is within this range. In this disclosure, unless specifically stated otherwise, relative terms, such as, for example, “about.” “substantially,” and “approximately” are used to indicate a possible variation of +10% in the stated value. The temperature range, used for comparison with the temperature of the main storage battery, may be stored in the memory 207 of the controller 200 (e.g., in one or more look up tables, etc.)

In some embodiments, the optimum range of battery temperature may change (e.g., expand, contract, move up or down, etc.) As an example, when the system is connected to external power, an optimum temperature may narrow as compared to operation on battery power only because there may be a greater amount of energy available to maintain the temperature within a tighter range (which may generally require more energy input). As another example, the temperature range may move down (but maintain the same number of degrees difference in the range) if the ambient temperature drops and the system is not connected to an external power source. The optimum range can change based on, for example, an ambient temperature as determined by the ambient temperature sensor 118, an availability of external power for connecting to the machine or energy storage system as relayed to the controller 200 by the external power available signal 208, a status of the auxiliary power system as relayed to the controller by the auxiliary power signal 216, a state of charge of a battery powering the temperature control system 106, etc. The range of values may be stored, for example, in the memory 207 of the controller or in the thermal management module 211. In some embodiments, the optimum range may change as battery technology (e.g., battery chemistry technology, etc.) changes. While specific ranges provided herein are merely exemplary, embodiments may generally adhere to the principle that a battery storage range is wider than a battery charge and discharge operating range, which is wider than a range in which the battery should be charged/discharged in order to maintain a lifecycle of the battery to the greatest extent (i.e., the optimum temperature range for charging the battery with respect to its length of useful life).

If the battery temperature is inside the desired temperature range, the system 100 may continue to monitor battery temperature using the battery temperature sensor 122 (i.e., circle back to step 406 from step 408). However, if the temperature of the main storage battery 102 is outside of the desired range (e.g., an optimum range) then the system may actuate the heating and/or cooling system 106 using external power in order to change the temperature of the main storage battery 102 at step 410. That is, the system 100 may automatically activate an externally powered thermal battery management mode based on the system 100 being in an externally powered mode and the temperature being outside of the desired range to heat or cool the main storage battery 102 based on the battery temperature of the main storage battery 102 as determined by the temperature sensor 122.

In some embodiments, the operational temperature range of the main storage battery 102 may be between about 0 to about 45 degrees Celsius for charging operations, between about −20 to about 60 degrees Celsius for discharging operations, and between about 0 to about 45 degrees Celsius for an overall range of operations (i.e., the temperature range within which the battery may operate in an ambient environment). In some aspects, a desired (e.g., target) operating range may be between about 10 to about 35 degrees Celsius. In some embodiments, the operational temperature range of the auxiliary battery 104 may be between about −20 to about 50 degrees Celsius.

Activating the heating and/or cooling system may include energizing one or more battery heaters (e.g., immersion heaters, heating coils, etc.), starting an HVAC system (e.g., a radiator, chiller, fans, pumps, compressor, etc.) configured to heat/cool the main storage battery 102, etc. At step 410, the heating or cooling system 106 is energized with the direct or indirect use of external power to maintain the main storage battery 102 temperature in an optimal range.

Because the temperature sensor 122 is powered by, at least, the auxiliary battery 104, the main storage battery 102 can be deenergized and the system can continue to monitor the temperature of the main storage battery 102. Accordingly, the temperature of the main storage battery 102 can be determined to be outside of a desired operational temperature range (e.g., an optimum range) even if the main storage battery 102 is not operating. In some embodiments, the temperature sensor 122 is also configured to receive electrical power from the main storage battery 102 such that, when the main storage battery is energized (e.g., providing power to the machine, in a maintenance mode, etc.), the temperature sensor 122 can be powered by the main storage battery 102. This provides redundancy to the temperature sensor 122 when the system is operating, in a maintenance mode, etc.

If the system is determined to not be connected to an external power source at step 404, the system 100 may use a different range of temperatures for activation of the temperature control system 106 (e.g., an HVAC system) (e.g., in an internally powered thermal management mode). At step 412, the system monitors the temperature of the main storage battery 102 using power from the auxiliary battery 104, similar to step 406. However, at step 414, the system may determine whether or not the battery temperature is approaching a critical bound in the operating range (e.g., about 0 degrees Celsius at a low end or about 45 degrees Celsius for the high end). The critical range may be a range of operational temperatures within which the main storage battery 102 must be kept in order for main storage battery 102 to continue to operate without damage to itself or associated systems. The critical range may be stored, for example, in the memory 207 and/or the thermal management module 211. In embodiments, the critical range may change based on one or more factors, updated, as appropriate, by the BMS system. For example, the critical range may move up or down or expand or contract based on an ambient temperature as sensed by, for example, the ambient temperature sensor 118 forming the ambient temperature signal 206. In some embodiments, the critical range may have a high critical temperature limit (e.g., 45 degrees Celsius for a charging operation) and low critical temperature limit (e.g., 0 degrees Celsius for the charging operation). The temperature control system may operate to maintain the temperature limit within a certain percentage of the critical temperature limits. For example, the temperature control system 106 may operate to maintain the main storage battery temperature a given percentage above the low critical temperature limit.

If the battery temperature approaches a critical range at step 414 as measured by the temperature sensor 122 the system 100 may activate the temperature control system 106 at step 416 to heat or cool the main storage battery 102 to avoid entering the critical range. That is, the system 100 may activate an internally powered thermal battery management mode (which may be a non-charging thermal management mode in some aspects) when not connected to an external power source to heat or cool the main storage battery 102 based on the temperature of the main storage battery 102 as sensed by the temperature sensor 122. The internally powered thermal battery management mode is different than the externally powered thermal battery management mode because, for example, the controller 200 may generate the cooling system activation signal 210 or the heating system activation signal 212 to cool or heat the main storage battery 102, respectively, to maintain the temperature within different limits than when operating in the externally powered battery management mode. In general, the internally powered battery management mode may have tighter limits for operating the temperature control system 106 because external power is not available to power the temperature control system 106 to maintain temperatures in the main storage battery 102.

In some embodiments, in the internally powered thermal battery management mode the temperature control system 106 may be powered by the auxiliary battery 104 such that the main storage battery 102 can be deenergized but temperatures of battery 102 are still monitored and/or controlled while it is deenergized. For example, the temperature sensor 122, the controller 200, and/or other related components may be powered and controlled by the auxiliary battery 104 and controlled by the temperature control system 106, respectively, while the main storage battery is deenergized. In some embodiments, in the internally powered thermal battery management mode the temperature control system 106 may be powered by the auxiliary battery 104 and/or the main storage battery 102 even in the internally powered battery management mode. For example, the temperature sensor 122, the controller 200, and/or other related components may be configured such that they are powered by the main storage battery 102 and the auxiliary battery 104 and controlled by the temperature control system 106.

In the internally powered battery management mode, the system 100 may continue to monitor the main storage battery temperature (e.g., with the temperature sensor 122) at step 418 to determine whether or not the battery temperature is approaching an upper or lower limit of the critical range (e.g., if the temperature control system is able to maintain the main storage battery temperature within limits). If the main storage battery 102 is energized and approaching a critical range at step 418, the system may initiate a derate at step 420 if unable to maintain a temperature of the main storage battery 102 below a critical range upper threshold despite the cooling system being activated. The controller 200 may activate the system derate signal 214 (as generated by, for example, the power management module 209) and the system 100 may derate until the battery 102 is able to maintain its temperature within operating limits (as measured by the temperature sensor 122). In some embodiments, the system may activate the main storage battery 102 in order to avoid approaching or decreasing below a low temperature threshold. For example, in the case when a battery is approaching a critical low temperature threshold and a heater or other temperature control system feature is unable to heat the battery. In such instance, the power management module 209 may generate a signal causing the battery to energize and increase its own temperature generating electrical energy.

It should now be understood that a battery temperature control system can be configured to maintain a main storage battery of a battery system in either a externally powered battery management mode or a internally powered battery management mode based on whether or not the system is connected to external power, external power is used to power heating/cooling system, and/or charge auxiliary battery, and/or main storage battery. Other aspects of the system can be changed based on whether the system is connected to external power, such as, for example, an operational temperature range of the main storage battery and/or set points for energizing a temperature control system. Such a system may enable batteries to remain within operational limits using a minimal amount of electrical power stored within the battery system, while expanding operational capabilities based on external power connection to the system, thus enabling greater functionality. Additionally, the system may enable prolonged operation of equipment powered by batteries by protecting batteries from overloaded conditions, which could overheat and damage them.

What is claimed is:

1. A method of thermally managing a battery system of a mobile machine, the method comprising:
enabling a sleep mode, the sleep mode causing the battery system to maintain a capability to control a temperature of a main storage battery of the battery system with a temperature control system while the machine is not in operation;
monitoring a battery temperature of the main storage battery using the temperature control system, wherein the temperature control system is configured to receive power from one or more of an auxiliary battery;
activating an externally powered battery management mode when connected to one or more external power sources, to heat or cool the main storage battery based on the battery temperature of the main storage battery as determined by the temperature control system, to charge the main storage battery, or to charge the auxiliary battery; and
activating an internally powered thermal battery management mode when isolated from external power sources, to heat or cool the main storage battery based on the battery temperature of the main storage battery, the internally powered battery management mode being different than the externally powered battery management mode.

2. The method of claim 1, wherein the temperature control system is configured to be powered by the auxiliary battery, the main storage battery, and the one or more external power sources.

3. The method of claim 1, wherein the sleep mode is enabled by a user of the machine using a user interface.

4. The method of claim 3, wherein the internally powered battery management mode further includes powering the monitoring of the battery temperature with an auxiliary battery.

5. The method of claim 4, wherein the internally powered battery management mode further includes powering the temperature control system with the main storage battery.

6. The method of claim 1, wherein the externally powered thermal management mode includes the auxiliary battery being charged by the one or more external power sources or by the main storage battery with the one or more external power sources charging the main battery.

7. The method of claim 6, wherein the auxiliary battery is configured to power the temperature control system.

8. A system for temperature control in a battery system configured to provide electrical power to a mobile machine from a main storage battery comprising:
a main storage battery configured to receive an electrical charge from an external charger;
a temperature control system;
an auxiliary battery;
a processor; and
a memory storing one or more instructions, that when executed by the processor cause the system to:
enable a sleep mode, the sleep mode causing the battery system to maintain a capability to control a temperature of the main storage battery of the battery system with the temperature control system while operation of the mobile machine is deenergized;
monitor battery temperature of the main storage battery using the temperature control system, wherein the temperature control system is powered by the auxiliary battery;
activate an externally powered thermal battery management mode when connected to external power sources to heat or cool the main storage battery based on the battery temperature of the main storage battery as determined by the temperature control system, to charge the main storage battery, or to charge the auxiliary battery; and
activate an internally powered battery management mode when not connected to external power sources to heat or cool the main storage battery based on the battery temperature of the main storage battery, the internally powered battery management mode being different than the externally powered thermal battery management mode.

9. The system of claim 8, wherein the sleep mode is enabled by a user of the machine using a user interface.

10. The system of claim 9, wherein the internally powered battery management mode further includes powering the monitoring of the battery temperature with an auxiliary battery.

11. The system of claim 10, wherein the internally powered battery management mode further includes powering the temperature control system with the main batteries.

12. The system of claim 8, wherein the temperature control system is configured to receive electrical power from the auxiliary battery and one or more external power sources.

13. The system of claim 12, wherein the auxiliary battery has a larger operational temperature range than the main storage battery.

14. The system of claim 8, wherein the externally powered thermal management mode includes the auxiliary battery being charged by the external power source or by the main storage battery with external power source charging the main battery.

15. The system of claim 8, wherein the internally powered battery management mode maintains a temperature of the main storage battery at least 10% above their critical temperature.

16. A method of thermally managing a battery system of a mobile machine, the method comprising:
enabling a sleep mode using a sleep mode enabling selection, the sleep mode causing the battery system to maintain a capability to control a temperature of a main storage battery of the battery system with a temperature control system while operation of the mobile machine is deenergized;
monitoring battery temperature of the main storage battery using the temperature control system, wherein the temperature control system is configured to operate between 0 to 45 degrees Celsius;
activating an externally powered thermal battery management mode when connected to external power sources to heat or cool the main storage battery based on the battery temperature of the main storage battery as determined by the temperature control system, to charge the main storage battery, or to charge an auxiliary battery; and
activating an internally powered battery management mode when not connected to external power to heat or cool the main storage battery based on the battery temperature of the main storage battery, the internally powered battery management mode being different than the externally powered thermal battery management mode.

17. The method of claim 16, wherein the sleep mode is enabled by a user of the machine using a user interface.

18. The method of claim 17, wherein the internally powered battery management mode further includes powering the monitoring of the battery temperature with an auxiliary battery.

19. The method of claim 18, wherein the internally powered battery management mode further includes at least partially powering the temperature control system with the main batteries.

20. The method of claim 16, wherein the main storage battery is a Li-ion battery and the auxiliary battery is a lead acid battery.
